(19) United States
(12) Patent Application Publication
(10) Pub. No.: US 2009/0015973 A1
(43) Pub. Date: Jan. 15, 2009

(54) Increased Voltage Vehicle Electrical System

(75) Inventors: Martin Trunk, Moeglingen (DE); Arndt Wagner, Eberdingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/792,036

(22) PCT Filed: Nov. 11, 2005
(86) PCT No.: PCT/EP05/55897

§ 371 Date: Jul. 25, 2008

(30) Foreign Application Priority Data
Nov. 30, 2004 (DE) 10 2004 057 694.7

(51) Int. Cl. H02H 3/16

(52) U.S. Cl. 361/42; 903/940

(57) ABSTRACT

A residual current protective circuit is integrated into a vehicle electrical system, in particular on the high-voltage side of a multiple-voltage vehicle electrical system, and operates without current measurement. The residual current is determined in an evaluation logic system by evaluating two voltages. These two voltages are voltages that drop at two high-impedance resistors, each of which being connected to ground between a connection between the battery and the generator. If the evaluation logic system detects a residual current, it opens both connections between the battery and the generator or the vehicle electrical system. In conjunction with a dual-voltage vehicle electrical system having two sub-systems connected by a DC voltage converter, a voltage-dependent circuit may be connected in parallel to the DC voltage converter, the parallel circuit grounding the high-voltage side in the event of a fault.

### FIELD OF THE INVENTION

The present invention relates to a vehicle electrical system having increased voltage. It includes in particular a residual current protective circuit and is used in a vehicle electrical system.

### BACKGROUND INFORMATION

It is understood that a protective circuit is integrated in electrical circuits that are suitable for higher voltages, the protective circuit responding if the energized areas of the circuit are contacted unintentionally and separating the normally present energy storage from the rest of the electrical system. Associated residual current monitoring systems normally operate using a current transformer that measures residual currents that occur. All current-carrying conductors are routed through the current transformer and the differential current is measured. If it is not equal to zero, the circuit breaker or the circuit breakers are opened.

FIG. 1 shows an example of such residual current monitoring in vehicles which is used in particular in vehicle electrical systems in which electrical voltages greater than 65 volts are present which can be hazardous to the human body on contact. According to this example of the use of a residual current protective circuit, a generator 1, for example, a three-phase generator, is present for generating voltage. The output voltage of the generator or of the three-phase generator is inverted using an inverter 2 and supplied to battery 6 via leads 3 and 4 and a switch 5. Inverter 2 is a bridge circuit designed for three phases having, for example, six pulse-controlled inverters.

The current flowing in leads 3, 4 is measured in an ammeter device, a current transformer 7 which determines the differential current, for example, being used for the current measurement. A control device 8 evaluates the measured current and opens switch 5 if the measured differential current exceeds predefinable values. Appropriate activation signals generated by control device 8 trigger the switching operation.

Since all current-carrying leads must be routed through current transformer 7, a relatively large and expensive current transformer is required. In addition, there is little flexibility when positioning the current transformer, since it must be situated in such a way as to include all current-carrying leads. Consequently, the residual current interruption after the output signals of a summation current transformer or of a forward converter are evaluated is quite complex.

The vehicle electrical system according to FIG. 1 may also be designed as a sub-system of a dual-voltage vehicle electrical system, for example, as a high-voltage side of a dual-voltage vehicle electrical system. The connection to the low-voltage side is then produced by a DC voltage converter which is, for example, connected to the generator.

DE 41 38 943 C1 describes an example of such a dual-voltage vehicle electrical system. In this dual-voltage vehicle electrical system, which is shown schematically in FIG. 2, DC voltage converter 26, which is situated between the two sub-systems, is a component of a complex charge/disconnect module which interrupts the connection between the two sub-systems as a function of supplied signals, for example, as a function of measured currents, and thus prevents reactions from one sub-system into the other in the event of a fault. The first sub-system includes a generator 27, a battery 28 and consumers 29; the second sub-system includes a battery 30 as well as consumers 31, for example, a starter. In both sub-systems, the negative terminal of batteries 28 and 30 is connected to ground. The reference numerals in brackets are explained in connection with FIGS. 3 and 4. Residual current detection is difficult to implement in a vehicle electrical system of this type.

In domestic electrical installations, so-called ground fault circuit interrupters are installed which provide increased safety against dangerous electrical shocks. Such ground fault circuit interrupters, also referred to as residual current circuit breakers, trip whenever a connection is produced between the neutral conductor and the protective conductor. Dangers are averted by disconnecting the part of the circuit downstream from the circuit breaker. Available esidual current protective devices are designed in such a way that they need only a low triggering current for triggering and have a relatively short break time.

### SUMMARY OF THE INVENTION

The increased voltage vehicle electrical system according to the exemplary embodiment and/or exemplary method of the present invention having a residual current protective circuit including the features of Claim 1 has the advantage that a residual current interruption is implemented without current measurement; it is usable in particular in a vehicle electrical system and is usable to particular advantage in a vehicle electrical system having a sub-area which is connected to increased voltage.

These advantages are obtained through a circuit in which the two connecting leads between the battery and the inverter or the generator connected to the inverter are connected to ground via at least one high-impedance resistor and the voltage dropping across these two resistors is measured. The two voltages are checked for a residual current using an evaluation logic system and in the event of a fault, i.e., if a residual current is detected, both leads are disconnected using a trip signal generated by the evaluation logic system which is supplied to the associated switches.

Additional advantages of the exemplary embodiment and/or exemplary method of the present invention are derived from the measures specified in the subclaims. A particular advantage is that solely by evaluating the measured voltage drop at the two resistors, i.e., without any additional measuring device and without additional sensors, it is possible to perform overvoltage and/or undervoltage monitoring. To prevent rapid load changes from resulting in potential shifts, capacitors may in addition be connected in parallel to the two resistors. A plausibility check, i.e., a comparison of the two measured voltages, makes it advantageously possible to differentiate between a load change and the occurrence of residual currents.

The response threshold at which the evaluation logic system emits a trip signal or an activation signal may advantageously be set to nearly any residual currents; advantageously, such a limiting value is less than 30 mA. The disconnection may occur very rapidly.

In the embodiment of an increased voltage vehicle electrical system in the form of a dual-voltage vehicle electrical system, an advantageous coupling of the two sub-systems is possible, which ensures that in the event of a fault on the high-voltage side, i.e., in the sub-system connected to the higher voltage, the high-voltage side is powerfully forced to contact ground. This advantage is obtained by connecting the two vehicle electrical systems coupled via a DC voltage converter using a switching element connected in parallel to the DC voltage converter, the switching element may monitor the voltage between the negative high-voltage terminal of the DC voltage converter and the vehicle electrical system ground and keeping it within specific limits. In an advantageous manner, the switching element is a voltage-dependent resistor, a Zener diode or a switching element that is controlled by the voltage difference between the negative voltage terminal and ground.

Using this circuit, which does not in fact represent a residual current circuit breaker, it is possible to ensure that the maximum allowable insulation voltage between the high-voltage and low-voltage area is not exceeded, or using such a circuit breaker, the system may be designed for a significantly lower insulation voltage, thus preserving a protection of the vehicle electrical system components or elements.

### BRIEF DESCRIPTION OF THE DRAWINGS

FIG. 1 shows a known and presently customary residual current protective circuit (described above).

FIG. 2 shows a known dual-voltage vehicle electrical system (described above).

FIG. 3 shows a block diagram for a vehicle electrical system having a residual current protective circuit according to the exemplary embodiment and/or exemplary method of the present invention.

FIG. 4 shows an arrangement for connecting two sub-systems connected to different voltages.

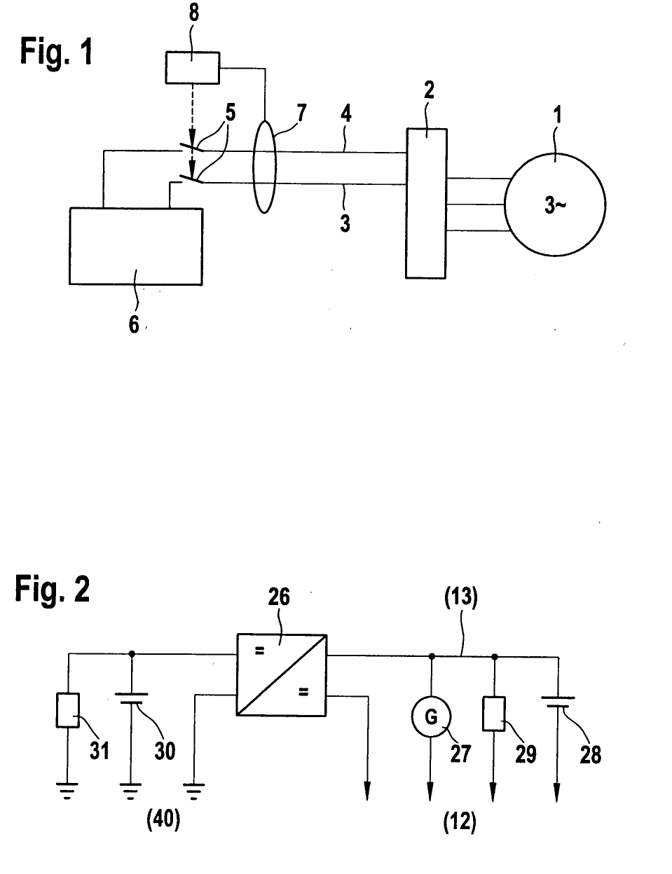

### DETAILED DESCRIPTION

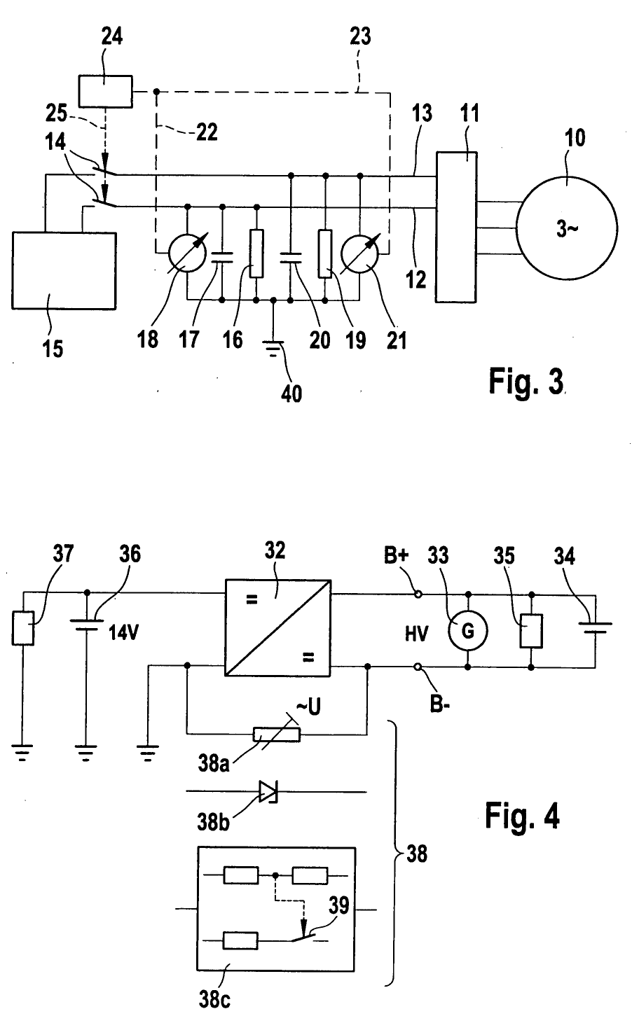

FIG. 3 shows the components of a vehicle electrical system or of a sub-system that are essential for an understanding of the exemplary embodiment and/or exemplary method of the present invention, which may be of the high-voltage sub-system together with a residual current protective circuit according to the exemplary embodiment and/or exemplary method of the present invention.

FIG. 3 shows in detail a vehicle electrical system or a sub-system having an electrical machine 10, for example a three-phase starter-generator 10 or an electrical machine for a hybrid vehicle electrical system, which is connected to an inverter 11 in the customary manner. Two leads 12, 13 lead from inverter 11, which is designed as a bridge circuit having, for example, six pulse-controlled inverters, to battery 15 via a switch 14. Via these connecting leads between battery 15 and inverter 11 or electrical machine 10, battery 15 is charged in the normal generating operation of electrical machine 10. If a starter-generator is used as electrical machine 10, the electrical machine may operate as a starter in the starting case, i.e., as an electric motor, and may be supplied with electrical power from battery 15 via inverter

In the exemplary embodiment according to FIG. 3, a parallel circuit made up of a resistor 16, a capacitor 17 and a voltmeter 18 is provided between lead 12 and ground, in particular vehicle or body ground 40. A resistor 19, a capacitor 20 and a voltmeter 21 are connected in parallel between lead 13 and ground. The two capacitors 17 and 20 are not absolutely necessary.

Both voltmeter 18, which measures the voltage drop at resistor 16, as well as voltmeter 21, which determines the voltage drop at resistor 19, are connected to evaluation logic system 24 and supply it with the measured variables to be evaluated. The associated connections between voltmeters 18 and 21 are denoted as 22 and 23, respectively. If evaluation logic system 24 detects a residual current by evaluating the voltages, it sends control signals to switch 14 via a connection 25 and disconnects the battery. This cuts off voltage to the vehicle electrical system. When predefinable conditions that make it possible to infer a fault are reached, both connecting leads 12, 13 between battery 15 and inverter 11 or generator 10 connected to inverter 11 are interrupted and residual current protection is assured.

The exemplary embodiment of the present invention according to FIG. 3 is distinguished in that it is possible to interrupt a residual current without current measurement. It is essential that high-voltage leads may also be in the vehicle electrical system, to which voltages substantially higher than 12 volts are applied. In a vehicle electrical system for a hybrid vehicle, the voltage on the high-voltage side is, for example, 65 volts and higher; however, substantially higher voltages of as much as 288 volts may also be applied under certain conditions. Under these conditions, a protection via a residual current circuit breaker is absolutely necessary. Such protection may also be expedient in a 12/42 vehicle electrical system.

In the exemplary embodiment according to FIG. 3, both connecting leads 12, 13 are connected to ground via at least one high-impedance resistor 16 and 19. This gives rise to a voltage divider which applies ground potential 40 between the potentials of leads 12 and 13. If a residual current now flows from lead 12 or lead 13 to ground 40, the voltage divider is “distorted”; the ratio of the voltages measured using voltmeters 18 and 21 changes and the residual current is thus detected. For residual current detection, the two measured voltages may, for example, be supplied to evaluation logic system 24 and the residual current detection is carried out in evaluation logic system 24. One possibility for error detection is, for example, to compare the determined voltage ratio with a limit value and to detect an error when this limit value is reached or exceeded. In the event of a fault, switch 14 trips, disconnecting the battery from the rest of the vehicle electrical system.

In the vehicle electrical system shown in FIG. 3, in contrast to the customary 12-volt vehicle electrical system, a high-voltage vehicle electrical system may have an increased voltage of, for example, 288 volts that is connected to the customary vehicle electrical system via, for example, a voltage transformer. In the embodiment shown in FIG. 3, the high-voltage system has no low-resistance connection to the vehicle ground. To prevent the potential of the high-voltage system from drifting away uncontrollably, high-impedance resistors 16 and 19 as well as capacitors 17, 20 are provided. If each pair is of equal size, the system is kept symmetrical to the vehicle ground. It is essential that the values of the resistors be kept high enough to prevent significant loss through the resistors; i.e., no relevant current flows from lead 12 across resistor 16 or from lead 13 across resistor 19 to ground. Expedient values for resistors 16 and 19 are, for example, 2 megaohms.

If a person touches one of leads 12 or 13 and simultaneously touches the vehicle or body ground, a residual current is produced which results in a significant potential shift. According to the exemplary embodiment and/or exemplary method of the present invention, this potential shift may be evaluated. In this connection, the person acts like a resistor that is connected in parallel to resistor 16 or 19. In this case, the voltage divider is thus also “distorted”; this may also be used for fault detection.

To prevent rapid load changes, i.e., rapid changes of the electrical system load from resulting in potential shifts, capacitors 17, 20 are connected in parallel to resistors 16, 19. If the two voltages, which are present or drop at resistors 16, 19, are measured, it is possible to infer that a residual current is clearly present. It is then necessary to measure both voltages. A plausibility check makes it possible to differentiate between load changes, i.e., between rapidly changing loads of the vehicle electrical system and residual currents.

Evaluation logic system 24 that detects the residual current from the comparison of the two voltages may be set to nearly any residual current, normally to a residual current of less than 30 milliamperes (mA). When the set residual current is reached, evaluation logic system 24 emits a corresponding signal to switch 15 and it opens.

In a vehicle having a dual-voltage electrical system, if no other protective measures are taken, the high-voltage system should for safety reasons be designed to be potential-free to ground, for example, to the housing, and also be touch-safe. This means that electrical isolation must be assured between the high-voltage and the low-voltage vehicle electrical system. This is in particular the case because the vehicle body represents the negative pole in the low-voltage vehicle electrical system which normally has a nominal voltage of 12 volts. At the same time, the high-voltage vehicle electrical system, which may, for example, be as high as 288 volts and possibly even higher, is connected to the body potential at high resistivity to prevent the electric potential from drifting randomly. This voltage connection is maintained by symmetry resistors 16, 19 and/or capacitors 17, 20. Given these facts, it is possible to determine if the total system is in order from the two measured voltages or voltage drops at resistors 17, 19 by comparing the voltages with one another.

If no fault is present and the electric potentials are within specifiable limits, the ratio of the resistance values of resistors 16 and 19 will be equal to the ratio of the two measured voltages. If due to contact or another error in the vehicle electrical system, the current in the high-voltage vehicle electrical system is entirely or partially drained off across the vehicle body, the resistive voltage divider is distorted accordingly because different currents flow through the two resistors 16, 19. It is possible for the change of the ratio of the two voltage drops which then occurs to be detected in evaluation logic system 24 and then trigger a reaction. This reaction may, for example, be an interruption of the high voltage. Such a reaction is triggered, for example, when the shift of the voltage divider reaches predefinable values. In turn, it is possible to select these values relatively freely.

FIG. 4 shows an embodiment of the dual-voltage vehicle electrical system according to FIG. 2, the coupling of the two sub-systems being implemented via DC voltage converter 32. The first sub-system includes a generator 33 including the inverter which is not shown separately, a battery 34 as well as consumers 35; the second sub-system has a battery 36 and consumers 37. The low-voltage electrical system (12/14 V) is connected to ground, the negative terminal of batteries 36 being connected to ground. In contrast, the high-voltage electrical system is connected as a controlled floating traction system, a switching element 38 additionally being connected in parallel to DC voltage converter 32 for the coupling with the low-voltage vehicle electrical system, this switching element being a voltage-dependent switching element that monitors the voltage between the negative high-voltage terminal (B−) and the vehicle electrical system ground and keeps them within certain limits.

Three possibilities for implementing switching element 38 are provided in FIG. 4. The negative terminal of the high-voltage side (B−) is connected to ground at more or less high resistivity either via a voltage-dependent resistor 38a, the value of which changes, for example, proportionally to voltage U, a Zener diode 38b or a switching element 38c which is controlled by the voltage difference between (B−) and ground. In principle, positive high-voltage terminal (B+) could also be connected to ground. Alternatively, a connection to the 14-V lead between the DC voltage converter and the battery would be possible instead of the ground connection.

The function of switching element 38 connected in parallel to DC voltage converter 32 in its embodiments is as follows: As soon as the reference potential of the high-voltage side exceeds a specific voltage in relation to the vehicle ground, the value of voltage-controlled resistor 38a drops and the reference potential of the high-voltage side is again drawn to ground, the curve being continuous. If a Zener diode 38b is used as switching element 38, the reference potential of high-voltage side 3 of the switching element is in contrast abruptly drawn to ground. If the voltage between the high-voltage side reference potential and ground is roughly equal to zero, the two electrical systems are not connected or are connected to one another only at very high resistivity.

In order to keep external interference from the high-voltage side to the 14-V vehicle electrical system as low as possible, it may be expedient to use an active switching element instead of a Zener diode or a voltage-dependent resistor. A possible embodiment is shown as 38c. Such a switching element 39 must be made up of at least one unit for voltage measurement and a switch. In order to suppress interference peaks when switching, a network made up of a coil, capacitor and resistor may be provided and situated upstream of the switch. In the event of a fault, the switch may be closed and the high-voltage side drawn to ground.

1-15. (canceled)

16. An increased voltage electrical system in a vehicle, comprising:
a residual current protective circuit, which includes:
at least one electrical machine,
an inverter,
two connecting leads between the inverter and a battery,
a switch for interrupting the two connections to the battery, and
an evaluation logic system to open the switch under predefinable conditions, wherein these conditions are voltages that drop at resistors, one of the resistors being connected between a first lead and ground and another of the resistors being connected between a second lead 13 and ground and the two leads, each connecting corresponding terminals of the battery to the inverter and the generator, respectively.

17. The system of claim 16, wherein a capacitor is connected in parallel to at least one of the resistors for preventing potential shifts under rapid load changes.

18. The system of claim 16, wherein the voltage drops at the resistors is determined using one ammeter for each, and measured values are supplied to the evaluation logic system via corresponding connections.

19. The system of claim 16, wherein the evaluation logic system forms a differential voltage from the two voltages supplied and determines the residual current from the differential voltage and opens the switch when a predefinable value for the residual current is reached.

20. The system of claim 19, wherein the predefinable limiting value of the current is selectable.

21. The system of claim 16, wherein the protective circuit is a component of a dual-voltage vehicle electrical system and is located on a side of the vehicle electrical system having a higher voltage.

22. The system of claim 17, wherein the values of the resistors are equal.

23. The system of claim 16, wherein ratios of the voltages dropping at the two resistors are evaluated for the residual current detection.

24. The system of claim 16, wherein plausibility checks are executed in the evaluation logic system for differentiating between load change and residual current.

25. The system of claim 16, wherein overvoltage and undervoltage monitoring is performed, in addition to detecting the residual current.

26. The system of claim 16, wherein the protective circuit is a component of an electrical system in a hybrid vehicle.

27. An increased voltage vehicle electrical system comprising two sub-systems which are connected to each other via a DC voltage converter and comprising a protective circuit, wherein one of the sub-systems is not connected to ground or is connected to ground only at very high resistivity and the protective circuit has a voltage-dependent circuit connected in parallel to the DC voltage converter and in the event of a fault draws to ground the sub-system which is not connected to ground.

28. The system of claim 27, wherein the voltage-dependent circuit has at least one of a voltage-dependent resistor and a Zener diode.

29. The system of claim 27, wherein the voltage-dependent circuit has at least one active switching element including one switch and one voltmeter.

30. The system of claim 27, wherein the protective circuit is a component of an electrical system in a hybrid vehicle.

31. The system of claim 19, wherein the predefinable limiting value of the current is 30 mA.

32. The system of claim 17, wherein the values of the resistors are equal and amount to two megaohms.
